(19) United States
(12) Patent Application Publication
(10) Pub. No.: US 2022/0223357 A1
(43) Pub. Date: Jul. 14, 2022

(54) METHOD FOR CARRYING OUT A SWITCHOVER OF AT LEAST ONE SWITCHING MEANS FOR EQUIPMENT, AND DRIVE SYSTEM FOR AT LEAST ONE SWITCHING MEANS FOR EQUIPMENT

(71) Applicant: Maschinenfabrik Reinhausen GmbH, Regensburg (DE)

(72) Inventors: Eduard Zerr, Regensburg (DE); Klaus Ixmeier, Thumhausen (DE); Benjamin Dittmann, Neutraubling (DE)

(21) Appl. No.: 17/609,411

(22) PCT Filed: Apr. 23, 2020
(86) PCT No.: PCT/EP2020/061286

§ 371 Date: Nov. 8, 2021

(30) Foreign Application Priority Data
May 15, 2019 (DE) 10 2019 112 718.1

(51) Int. Cl. H01H 9/00; H01H 3/26

(52) U.S. Cl. CPC H01H 9/0027; H01H 2003/266; H01H 2009/0061; H01H 3/26

(57) ABSTRACT

A method carries out a switchover of a switch for at least one item of equipment. The method includes receiving, by a controller, a switching signal; selecting the at least one switch for switchover the controller on the basis of the switching signal; checking a locking condition for the selected switch on the basis of at least one parameter; and carrying out the switchover by the at least one selected switch by a motor of the switch upon determining that the corresponding locking condition is met.

### CROSS REFERENCE TO RELATED APPLICATIONS

This application is a U.S. National Phase application under 35 U.S.C. § 371 of International Application No. PCT/EP2020/061286, filed on Apr. 23, 2020, and claims benefit to German Patent Application No. DE 10 2019 112 718.1, filed on May 15, 2019. The International Application was published in German on Nov. 19, 2020 as WO 2020/229125 A1 under PCT Article 21(2).

### FIELD

The invention relates to a method for carrying out a switchover of at least one switching means for equipment. The invention further relates to a drive system for at least one switching means for equipment.

### BACKGROUND

German laid-open specification DE 10 2014 110 732 A1 discloses an on-load tap-changer with a motor drive for switching over between winding taps of a tap-changing transformer. A drive shaft is driven by means of the motor drive. The rotational movement of the motor drive is provided via two switchable coupling devices of a first drive shaft, which is associated with the selector, and a second drive shaft, which is associated with the diverter switch. The selector and the diverter switch can be designed to be switchable in relation to one another independently of the initial rotational movement of the motor drive.

Voltage regulation in energy transmission and energy distribution networks requires different types of switches to be installed in the transformers. Different factors play a role during operation of the transformer and therefore also the switches. For example, in transformers with two installed on-load tap-changers, operation of said two on-load tap-changers has to be coordinated. This is performed by means of a rigid rod between the two on-load tap-changers, which rod is driven by a common motor. Incorrect coupling of the rod can cause problems during operation, and this can have serious technical and economic consequences in extreme cases.

### SUMMARY

In an embodiment, the present invention provides a method for carrying out a switchover of a switcher for at least one item of equipment. The method includes receiving, by a controller, a switching signal; selecting the at least one switcher for switchover by means of the controller on the basis of the switching signal; checking a locking condition for the selected switcher on the basis of at least one parameter; and carrying out the switchover by means of the at least one selected switcher by means of a motor of the switcher if the corresponding locking condition is met.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a drive system for at least one switching means in a transformer, according to one embodiment of the invention;

FIG. 2 shows a further embodiment of a drive system for at least one switching means in a transformer, according to a further embodiment of the invention;

FIG. 3 shows a yet further embodiment of a drive system for at least one switching means in a transformer;

FIG. 4 shows an embodiment of a drive system for a plurality of transformers; and

FIG. 5 shows a method sequence for carrying out a switchover of at least one switching means in a transformer by means of a drive system according to the invention.

### DETAILED DESCRIPTION

Embodiments of the present invention provide a method for carrying out a switchover of at least one switching means for equipment, by way of which method the security and reliability of the switching means and the equipment are increased.

Exemplary embodiments provide a method for carrying out a switchover of a switching means for equipment.

A further embodiment provides an improved concept for a drive system of a switching means, by way of which concept the security of the switching means and the equipment is increased.

A further embodiment of the invention provides a drive system for at least one switching means for equipment, by way of which drive system the security and reliability of the switching means and the equipment during the switchover process are increased.

Embodiments may achieved these advantages by way of a drive system for at least one switching means for equipment.

A method according to an exemplary embodiment of the invention for carrying out a switchover of at least one switching means, which is associated with equipment, is distinguished in that a control unit or control device receives a switching signal. At least one of the switching means is selected for switchover by means of the control unit. This is done on the basis of the switching signal. At least one parameter is queried by way of the control unit from a feedback system. A feedback system can be associated with a motor of each switching means. The switchover is carried out using the selected switching means by means of a motor which is connected to the respective switching means via a drive shaft. Here, the switchover is performed only if the corresponding locking condition for the selected switching means is met.

The switching signal can be generated, for example, by a voltage regulator, manual input or in any other desired manner. Here, the voltage regulator monitors voltage fluctuations in the network. Depending on requirements, a signal is passed to the control unit, so that a voltage is correspondingly adjusted by operating the switching means.

The method according to an exemplary embodiment of the invention is based on, among other things, the idea that a locking condition in a control unit or control device is checked before a switching means in equipment, such as a transformer for example, is operated or switched and a switchover is carried out. A parameter is queried for this check. If the locking condition is met by the queried parameter, the switchover is performed.

In a first possible embodiment of the method according to the invention, an on-load tap-changer is associated with the transformer as a first switching means and a double reversing change-over selector is associated with said transformer as a second switching means. For carrying out the switchover, a power section, which is associated with the transformer, is actuated by the control unit for operating the on-load tap-changer or the on-load tap-changer and the double reversing change-over selector. A first motor, which is connected to the on-load tap-changer via a drive shaft, and/or a second motor, which is connected to the double reversing change-over selector via a drive shaft, are operated depending on the switchover being carried out.

According to a further possible embodiment of the method according to the invention, three on-load tap-changers are associated with the transformer as a first switching means. For carrying out the switchover, a power section, which is associated with the transformer, is actuated by the control unit for operating one of the three on-load tap-changers. The power section operates a first motor of each on-load tap-changer via a drive shaft, which is connected to the on-load tap-changer, depending on the switchover being carried out.

According to a further possible embodiment of the method according to the invention, an on-load tap-changer can be associated with the transformer as a first switching means and two double reversing change-over selectors can be associated with said transformer as a second switching means. For carrying out the switchover, a power section, which is associated with the transformer, are actuated by the control unit for operating the on-load tap-changer and at least one of the two double reversing change-over selectors. The power section operates a first motor, which is connected to the on-load tap-changer via a drive shaft, and a second motor, which is connected to each of the two double reversing change-over selectors via a drive shaft, depending on the switchover being carried out.

In accordance with the method according to the invention, the parameters, which are ascertained by way of the feedback systems, for the switchover of the at least one on-load tap-changer and/or for the switchover of the at least one double reversing change-over selector are available for a position or location of the respective on-load tap-changer and the respective double reversing change-over selector. The parameter, which is ascertained by way of the feedback systems, of the on-load tap-changer and double reversing change-over selector which are required for the switchover can further indicate whether the on-load tap-changer and/or the double reversing change-over selector are presently being operated.

In accordance with the method according to the invention, the queried parameters of the at least one on-load tap-changer and the at least one double reversing change-over selector are evaluated and combined in the control unit. The at least one on-load tap-changer and/or the at least one double reversing change-over selector can be actuated as needed on the basis of the result of the evaluation. According to another refinement of the method according to an embodiment of the invention, three transformers are provided. A power unit is associated with each of the three transformers. The power units are actuated by the central control unit, wherein the on-load tap-changer of each of the three transformers are combined to form a first switching means group, the first double reversing change-over selectors of each of the three transformers are combined to form a second switching means group and the second double reversing change-over selectors of each of the three transformers are combined to form a third switching means group.

In the embodiments, described here, of the method according to the invention, the on-load tap-changers and double reversing change-over selectors present are checked by a control unit. The result of the check shows which location the on-load tap-changers or the double reversing change-over selectors are in. The parameter for the locking condition to be checked is therefore the location of the on-load tap-changer and/or the double reversing change-over selector, which location is ascertained by means of the feedback system.

The feedback system can be an encoder, a multi-turn rotary encoder, a single-turn rotary encoder, a resolver, a switch, a microswitch, a sensor, a contact, etc. It is self-evident to a person skilled in the art that this list of possible configurations for the feedback system is not exhaustive.

The feedback system serves to determine the parameter, which is necessary for checking a locking condition. The parameter can be dependent on the feedback system. Depending on the configuration, the parameter is a value, a value range, a simple signal, etc.

The feedback system, which is queried by a control unit, can also be associated with or be designed as a temperature regulator, protective switch or the like, depending on requirements. Therefore, any desired parameter, which is queried by a feedback system, can also be used for a locking condition. For example, a specific temperature as a parameter of a thermometer can be used to meet a locking condition. Furthermore, a parameter using a status of a circuit breaker can be used. In this case, the feedback system is an encoder which outputs the parameter that the circuit breaker is open or closed or is presently being opened or closed. In accordance with the locking condition, the status of the circuit breaker is used to check whether the switching means to be operated may/must be operated. The drive system according to the invention for at least one on-load tap-changer and/or at least one double reversing change-over selector of a transformer is distinguished by way of a first motor, which is connected to the at least one on-load tap-changer via a drive shaft. In each case one second motor is connected to the at least one double reversing change-over selector via a drive shaft. In each case one feedback system is associated with each of the first motors and each of the second motors in order to ascertain at least one parameter of the at least one on-load tap-changer and/or the at least one double reversing change-over selector. A control unit, which is connected in a communicating manner to a power unit, can operate the on-load tap-changer using the first motor and the double reversing change-over selector using the second motor. The on-load tap-changer and, respectively, the double reversing change-over selector are operated only when the locking conditions, which are determined by the at least one ascertained parameter, are met. As an alternative to the parameter of the second feedback system at the second switching means, the parameter can also be ascertained by another feedback system, for example a protective contact or thermometer.

According to one possible refinement of the drive system, a single on-load tap-changer and a single double reversing change-over selector are associated with the transformer.

According to one possible further refinement of the drive system, three on-load tap-changers are associated with the transformer. Specific switching positions or locations of the switching means, which are associated for example with a value for the position of the drive shaft, can be stored in the memory.

According to a yet further refinement of the drive system, a single on-load tap-changer and two double reversing change-over selectors are associated with the transformer.

According to a broad refinement of the drive system, a plurality of transformers are associated with said drive system. A power unit is associated with each of the transformers and the power sections are connected in a communicating manner to a single central control unit. The on-load tap-changers of the plurality of transformers are combined to form a first switching means group. The first double reversing change-over selectors of the plurality of transformers are combined to form a second switching means group. The second double reversing change-over selectors of the plurality of transformers are combined to form a third switching means group. A dedicated power section can be allocated to each motor. One power section can also drive all of the motors.

The control unit and/or the power unit may comprise/comprises a memory. Specific switching positions or locations of the switching means, which are associated for example with a value for the position of the drive shaft, can be stored in the memory.

The invention and its advantages will now be explained in more detail using exemplary embodiments with reference to the appended drawings, without limiting the invention to the exemplary embodiment shown in so doing. The relative sizes of elements in the figures do not always correspond to the real relative sizes of elements since some forms are simplified and other forms are increased in size in comparison to other elements for improved illustration. Identical reference symbols may be used for elements of the invention which are the same or have the same effect.

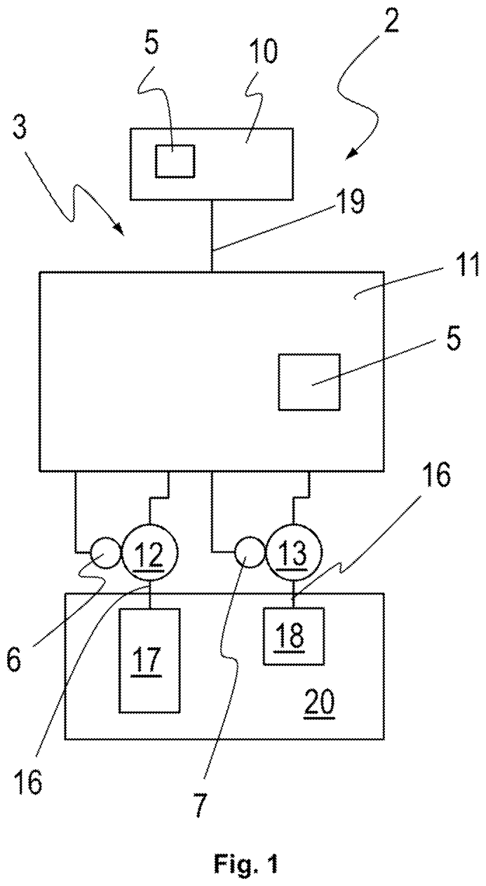

The exemplary embodiment of FIG. 1 shows a transformer 20 which is used for energy transmission. The transformer has a first switching means 17, which is designed as an on-load tap-changer, and a second switching means 18, which is designed as a double reversing change-over selector. The on-load tap-changer 17 is operated by means of a first motor 12. The first motor 12 has a drive shaft 16 which is connected to the on-load tap-changer 17. Furthermore, a first feedback system 6, with which the position or tap position of the on-load tap-changer 17 can be determined, is associated with the first motor 12. The double reversing change-over selector 18 is operated via a second motor 13. This second motor 13 is also connected to the double reversing change-over selector 18 via a drive shaft 16. A dedicated feedback system 7 of the second motor 13 allows the position or tap position of the double reversing change-over selector 18 to be determined. A control unit 10 is connected to the first and second motors 12, 13 and therefore also to the feedback systems 6, 7 of the on-load tap-changer 17 and the double reversing change-over selector 18. The control unit 10 receives signals for operating the on-load tap-changer 17 and the double reversing change-over selector 18. Furthermore, different values of the respective feedback systems 6, 7 are evaluated and combined in the control unit 10. The control unit 10, the motors 12, 13 and the feedback systems 6, 7 form the drive system 3 for the on-load tap-changer 17 and the double reversing change-over selector 18 of the transformer 20.

The control device 2 according to the invention comprises the control unit 10 which receives switching signals during operation. If, for example, the voltage in the network drops, said voltage has to be adjusted, for example by operating the on-load tap-changer 17 of the transformer 20. Owing to the use of a double reversing change-over selector 18 with corresponding interconnection of the windings of the transformer 20, the regulating range or functional range of a transformer 20 is extended. After the signal that the voltage has to be changed is received, it is initially determined whether the on-load tap-changer 17 or the double reversing change-over selector 18 has to be operated or whether both have to be operated in succession. After it has been determined that the on-load tap-changer 17 has to be operated, the locking conditions, which were defined between the double reversing change-over selector 18 and the on-load tap-changer 17, are checked. For example, an on-load tap-changer 17 must not be operated if the double reversing change-over selector 18 is presently being operated. The checking is performed in such a way that the second feedback system 7 of the second motor 13 of the double reversing change-over selector 18 of the control unit 10 reports the current status or transmits parameters. In this case, the location or position of the double reversing change-over selector 18 is determined and transmitted via the second feedback system 7. Furthermore, the second feedback system 7 reports whether the double reversing change-over selector 18 is currently being operated. If the ascertained parameters meet the locking conditions, the on-load tap-changer 17 is operated. If the locking conditions have not been met, the on-load tap-changer 17 is not operated. As an alternative, switching or operation of the on-load tap-changer 17 can be delayed until the locking conditions are met, that is to say the double reversing change-over selector 18 is in a specific position or is no longer moving.

The control device 2 comprises the control unit 10 with a memory 5 and at least one power section 11 with a memory 5. For example, association of switching positions of the on-load tap-changer 17 and the double reversing change-over selector 18 can be stored in the memory 5. Similarly, the values for the positions of the individual drive shafts 16 can be stored in the memory 5.

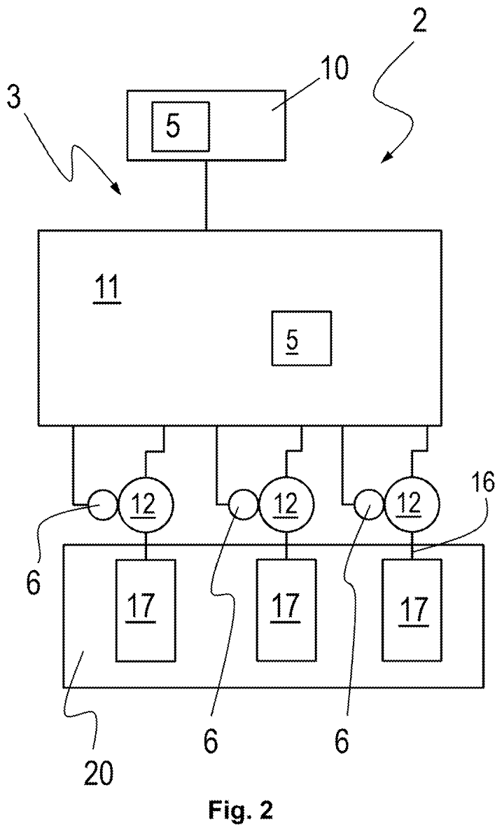

FIG. 2 shows the above-described drive system 3 for three identical on-load tap-changers 17 which are associated with the one transformer 20. Here too, each on-load tap-changer 17 has a dedicated first motor 12 and a dedicated first feedback system 6. After a switching signal is received, a check is first made in respect of which of the three on-load tap-changers 17 is to be operated. It is also conceivable to select an order for operation of the on-load tap-changers 17. The locking conditions are also checked here. This is performed on the basis of the transmitted parameters of the respective first feedback systems 6. A check is also made here in respect of which location the on-load tap-changer or changers 17 that are not to be operated is/are in or whether said on-load tap-changer or changers is/are presently being operated. If the ascertained parameters meet the locking conditions, the selected on-load tap-changer 17 can be operated.

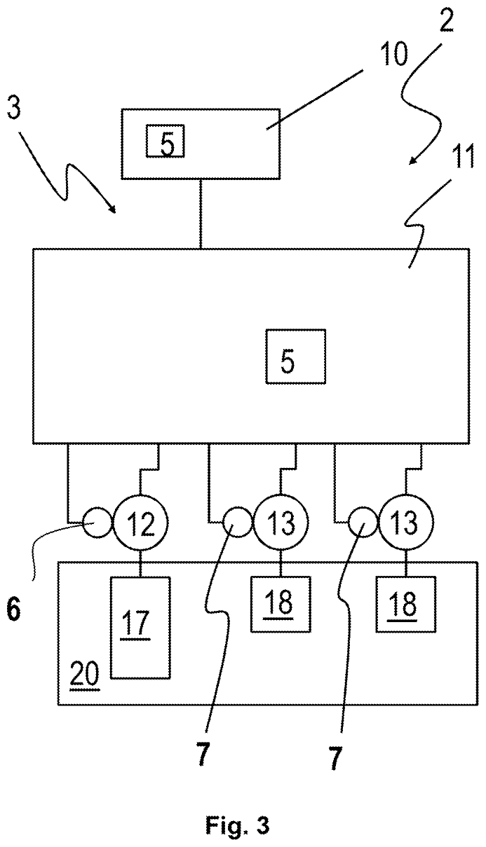

FIG. 3 shows a further embodiment of the described drive system 3. In this case, an on-load tap-changer 17 and two double reversing change-over selectors 18 as second switching means 18 are provided. The on-load tap-changer 17 and the two double reversing change-over selectors 18 are operated by a dedicated first motor 12 and, respectively, a dedicated second motor 13. A first feedback system 6 and, respectively, a second feedback system 7 are allocated to each of the motors 12 and 13. Here too, different locking conditions can be checked in the control unit 10 by way of the parameters of the feedback systems 6 and, respectively, 7 being queried. For example, in this embodiment, operation of the second double reversing change-over selector 18 is possible only when the first double reversing change-over selector 18 is in a secure location and the on-load tap-changer 17 is in the central position. A specific first position or second position of the double reversing change-over selector 18 is defined as a secure location.

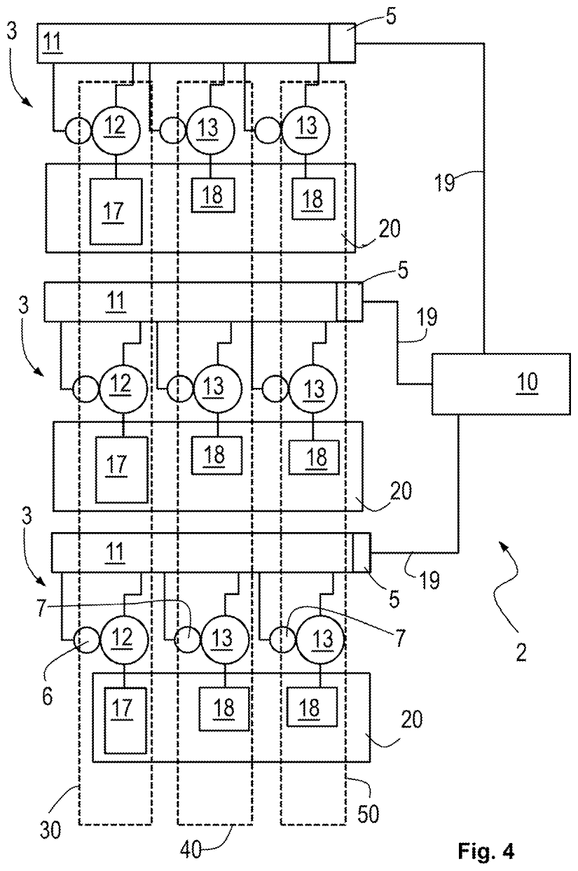

FIG. 4 shows a further embodiment of the described drive system 3. Three transformers 20 are illustrated here. The embodiment described here is a phase shifter with in-phase and quadrature regulation. Each of the transformers 20 has an on-load tap-changer 17 (first switching means) and two double reversing change-over selectors 18 (second switching means). The component placement of the transformer 20 corresponds to the component placement of the embodiment from FIG. 3. After a switching signal is received, a check is first made in respect of which of the on-load tap-changer 17 and/or double reversing change-over selector 18 has to be operated. Switching means groups 30, 40, 50 can be formed for this purpose. For example, a first vector group 30 consists of the on-load tap-changers 17 in the respective transformers 20. A second switching means group 40 is made up of the first double reversing change-over selectors 18. A third switching means group 50 is made up of the respectively second double reversing change-over selectors 18. Before operation, a check is then made in respect of whether the determined switching means group 30, 40, 50 meets the locking conditions. For example, a check is made here in respect of which position each individual first double reversing change-over selector 18 is in and whether one of these is moving. The locking conditions are checked on the basis of the parameters of the respective feedback systems 6 and 7. One of the locking conditions is that one of the switching means groups 40, 50 can be operated only when the on-load tap-changers 17 of the first switching means group 30 are in a so-called central position. The power section 11, which is associated with each drive system 3 of each transformer 20, is connected to a central and single control unit 10 using a bus 19. The operation of the respective on-load tap-changers 17 or double reversing change-over selectors 18 for each of the three transformers 20 is coordinated and controlled by means of the central control unit 10. As shown in FIGS. 1 to 3, the power section 11 accesses the motors 12 or 13 that are associated with the on-load tap-changer 17 or double reversing change-over selector 18 or operates them.

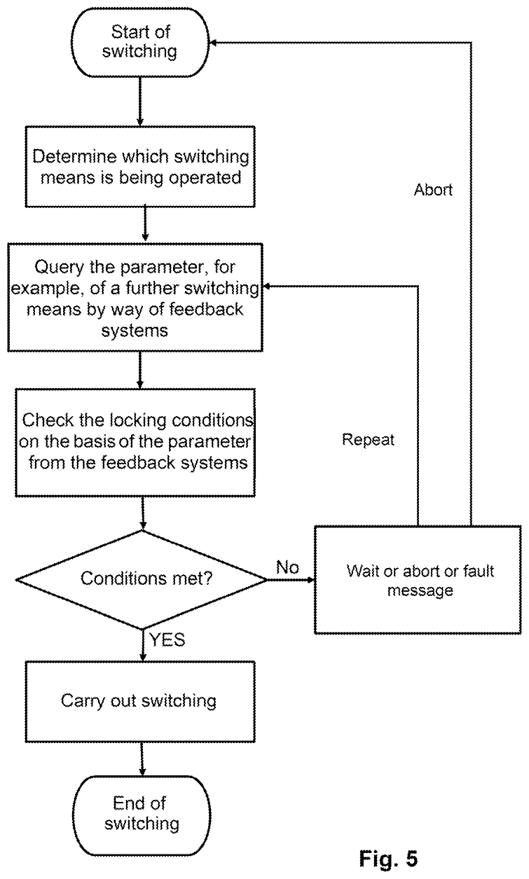

FIG. 5 shows a method sequence according to the invention. Here, the control device 2 receives a switching signal for operating an on-load tap-changer 17 and/or a double reversing change-over selector 18. This switching signal can be generated, for example, by manual input during maintenance work. As an alternative, the switching signal can be provided by a device for voltage regulation if, for example, the voltage across the transformer 20 falls or rises. After the switching signal is received, the control unit 10 queries at least one parameter. In the example from FIG. 1, the queried parameter is the location of the double reversing change-over selector 18, that is to say the second switching means 18, which location is determined by the associated feedback system 6 of the first motor 12. In the control unit 10, at least one locking condition, which can be met or cannot be met by the at least one parameter, is stored in a memory 5. If said locking condition is met in the check for the locking condition, the switchover of the on-load tap-changer 17 is performed by means of the first motor 12 that is associated with it. If the locking condition is not met in the check, operation of the on-load tap-changer 17 can be aborted for example, that is to say no switchover is performed either. Furthermore, a fault message can be generated. However, switching can also be carried out in spite of the locking condition not being met if there is an emergency situation. The control unit 10 can then wait until the parameter meets the locking condition and then carries out the switchover. As an alternative, the switchover can already be aborted before the start. Proceeding from the example in FIG. 1, before the operation of an on-load tap-changer 17, a check would first be made in respect of which position (location) the double reversing change-over selector 18 is located in and/or whether it is presently moving, that is presently being operated. On account of the locking conditions in this example, the on-load tap-changer 17 must not be operated if the double reversing change-over selector 18 is presently being operated or, for example, is in an unsuitable/impermissible position (location). The parameters required for checking the locking conditions are output by the second feedback system 7 of the second motor 13 of the double reversing change-over selector 18. Here, the feedback system 6 or 7 is designed, for example, as a multi-turn rotary encoder which is directly or indirectly connected to the drive shaft 16 which is arranged between the second motor 13 and the double reversing change-over selector 18. The multi-turn rotary encoder then determines the parameters, such as the location of the double reversing change-over selector 18, on the basis of the position of the drive shaft 16. The first feedback systems 6 of the on-load tap-changers 17 are configured in an analogous manner.

Different parameters can be combined with different locking conditions, depending on the configuration of the drive system 3. For example, as shown in the embodiment in FIG. 3, the location (position) of the two double reversing change-over selectors 18 is checked before the on-load tap-changer 17 is operated. As an alternative, the locking conditions, that is to say the parameters of the on-load tap-changer 17 and the first double reversing change-over selector 18, are checked before the second double reversing change-over selector 18 is operated. Here too, the parameters are queried via the respective feedback systems 6 and 7 which are designed as multi-turn rotary encoders.

The parameters to be queried can be determined in any desired manner or can be of any desired type. The parameters can be determined from feedback systems 6 and 7 at the motors 12 and 13 of the respective on-load tap-changers 17 and the respective double reversing change-over selectors 18, which feedback systems can be simple safety switches for the transformer 20 or even customer-specific release buttons. Furthermore, the feedback system 6 and 7 could be part of the control unit 10 which counts the operations or stops a time and makes available from here a parameter, which is to be queried, for a locking condition.

The feedback systems 6 and 7 are directly or indirectly connected to the drive shafts 16, which are arranged between the respective motor 12 or 13 and the on-load tap-changer 17 and, respectively, the double reversing change-over selector 18. The parameters, such as tap position, movement, etc. for example, for the on-load tap-changers 17 or the double reversing change-over selector 18 are determined from the positions of the drive shaft 16.

The locking conditions define which states have to be satisfied in order that a switchover is not “locked”, that is to say blocked. These conditions are linked to parameters which are formed or defined by positions or locations of the on-load tap-changer 17 and, respectively, the double reversing change-over selector 18, current status and movement states.

The locking conditions can use one or more parameters of one or any desired number of feedback systems 6, 7.

The parameters include, for example, the movement states of the on-load tap-changers 17 and, respectively, the double reversing change-over selectors 18, location or position of the on-load tap-changers 17 and, respectively, the double reversing change-over selectors 18, the location range or position range of the on-load tap-changers 17 and, respectively, the double reversing change-over selectors 18, temperatures, customer-specific switching signals, safety devices and the like.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SYMBOLS

2 Control device
3 Drive system
5 Memory
6 First feedback system
7 Second feedback system
10 Control unit
11 Power section
12 First motor
13 Second motor
16 Drive shaft
17 On-load tap-changer, first switching means
18 Double reversing change-over selector, second switching means
19 Bus
20 Transformer
30 First switching means group
40 Second switching means group
50 Third switching means group

1. A method for carrying out a switchover of at least one switch for at least one item of equipment, the method comprising:
receiving, by a controller, a switching signal;
selecting the at least one switch for switchover by the controller on the basis of the switching signal;
checking a locking condition for the selected switch on the basis of at least one parameter; and
carrying out the switchover by the at least one selected switch by a motor of the switch upon determining that the corresponding locking condition is met.

2. The method as claimed in claim 1, the method comprising evaluating, by the controller, a plurality of parameters for the selected switch so that the selected switch is actuated as needed in accordance with the corresponding locking conditions.

3. The method as claimed in claim 1, the method comprising querying the parameter by way of the controller from a feedback system which is associated with a first motor of a first switch or a second motor of second switch.

4. The method as claimed in claim 3, wherein the feedback system is associated with a drive shaft for the first motor or a drive shaft for the second motor.

5. The method as claimed in claim 1, wherein a power section, which is associated with the equipment, is actuated by the controller for operating the switch and the power section operates a first switching using a first motor via a drive shaft depending on the ascertained locking condition.

6. The method as claimed in claim 1, wherein three items of equipment, comprising the at least one item of equipment are provided and power sections are respectively associated with each of the three items of equipment and the power sections are actuated by the central controller, wherein a first switch for the three items of equipment are combined to form a first switch group, and at least two second switch for the three items of equipment are combined to form a second switch group and a third switch group.

7. The method as claimed in claim 3, wherein the equipment is a transformer, wherein the first switch is an on-load tap-changer and the second switch is a double reversing change-over selector.

8. The method as claimed in claim 7, wherein three on-load tap-changers are associated with the transformer as the first switch, wherein, for carrying out the switchover, a power section, which is associated with the transformer, is actuated by the controller for operating one of the three on-load tap-changers and the power section operates a first motor of each on-load tap-changer via a drive shaft depending on the switchover being carried out.

9. The method as claimed in claim 7, wherein the on-load tap-changer is associated with the transformer as the first switch and the respective double reversing change-over selector is associated with the transformer as the second and a third switch, wherein, for carrying out the switchover, a power section, which is associated with the transformer, is actuated by the controller for operating the on-load tap-changer and at least one of the two double reversing change-over selectors and the power section operates the first motor, which is connected to the on-load tap-changer via a first drive shaft, and the second motor, which is connected to each of the two double reversing change-over selectors via a second drive shaft, depending on the switchover being carried out.

10. The method as claimed in claim 7, wherein the parameters, which are ascertained by way of the feedback systems, for the switchover of the at least one on-load tap-changer or for the switchover of the at least one double reversing change-over selector is a location or position of the respective on-load tap-changer or the double reversing change-over selector.

11. The method as claimed in claim 10, wherein the ascertained parameter of the feedback systems of the on-load tap-changer and double reversing change-over selector which are required for the switchover indicates whether the on-load tap-changer or the double reversing change-over selector are presently being operated.

12. A drive system for at least one switch for equipment, the drive system comprising:
a first motor which is mechanically coupled to the first switch, of the at least one switch, for the equipment via a first drive shaft; and
a controller which is connected in a communicating manner to a power section in order to operate the first switch using the first motor, in which, by at least one ascertained parameter that is configured to be evaluated in the controller, a corresponding locking conditions is configured to be met.

13. The drive system as claimed in claim 12, the drive system being provided for two switches, comprising the switch, for equipment, the drive system comprising:
at least one second switch, of the switches;
a second motor which is mechanically coupled to the second switch via a second drive shaft; wherein
the controller is connected in a communicating manner to a power unit and configured to operate the second switch using the second motor, in which, by at least one ascertained parameter that is configured to be evaluated in the controller, the corresponding locking condition is configured to be met.

14. The drive system as claimed in claim 12, wherein a feedback system is associated with the first motor and a second motor in order to ascertain at least one parameter of the first switch and at least one parameter of at least one second switch.

15. The drive system as claimed in claim 14, wherein the feedback system is associated with a drive shaft for the first motor or a drive shaft for the second motor.

16. A plurality of drive systems for each of three items of equipment, the drive systems comprising the drive system as claimed in claim 12, the three items of equipment comprising the equipment, and a plurality of power sections, comprising the power section,
wherein for each of the drive systems, the respective power section is associated with the respective drive system and the respective power sections are connected to a central controller via a respective bus, wherein the first switch of each of the drive systems are combined to form a first switch group, and at least two second switches of the drive systems are combined to form a second switch group or a third switch group.

17. The drive system as claimed in claim 12, wherein the equipment is a transformer, the first switch is an on-load tap-changer and wherein a second switch is a double reversing change-over selector.

18. The drive system as claimed in claim 17, wherein three on-load tap-changers are associated with the transformer.

19. The drive system as claimed in claim 17, wherein a single on-load tap-changer and two double reversing change-over selectors are associated with the transformer.

20. The drive system as claimed in claim 12, wherein the controller or the power unit comprise a memory.
